(19) United States
(12) Patent Application Publication
(10) Pub. No.: US 2022/0099241 A1
(43) Pub. Date: Mar. 31, 2022

(54) PIVOTAL SUPPORT MECHANISM FOR MOBILE DEVICE

(71) Applicant: Oxti Corporation, Taipei (TW)

(72) Inventor: Chih Feng HO, Taipei (TW)

(21) Appl. No.: 17/034,696

(22) Filed: Sep. 28, 2020

(51) Int. Cl. F16M 11/10

(52) U.S. Cl. CPC F16M 11/10; F16M 2200/022

(57) ABSTRACT

A pivotal support mechanism includes a supporting base, a lever having one end portion pivotally and frictionally attached to the supporting base for allowing the lever to be rotated and adjusted relative to the supporting base to a selected angular position, and a beam having one end portion pivotally and frictionally attached to another end portion of the lever for allowing the beam to be rotated and adjusted relative to the lever to a selected angular position, and the lever includes an opening formed in the other end portion of the lever, and an electric facility is pivotally and frictionally attached to the other end portion of the beam for allowing the electric facility to be rotated and adjusted relative to the beam to a selected angular position.

### BACKGROUND OF THE INVENTION

### 1. Field of the Invention

The present invention relates to a pivotal support mechanism for a monitor or displayer or mobile device, and more particularly to a pivotal support mechanism including a foldable and pivotal structure or configuration for suitably supporting the monitor or displayer or screen or mobile device at any suitable or selected position and for allowing the displayer or the monitor or the screen or the mobile device or the like to be easily and readily viewed or seen by the user.

### 2. Description of the Prior Art

Typical pivotal support mechanisms or tables normally comprise a stand or arm or lever disposed or supported on a table plate or table top or a supporting base for supporting various objects or electric facilities, such as mobile devices, tablets, screens, computers, laptops, notebooks, etc.

However, the typical pivotal support mechanisms have no hinges or pivot joints or the like such that the objects, the electric facilities, the mobile devices, the tablets, the screens, the notebooks, the displayers, the monitors or the like may not be suitably and pivotally or rotatably adjusted relative to the table plate or the table top or the supporting base and thus may not be easily and readily viewed or seen by the user.

The present invention has arisen to mitigate and/or obviate the afore-described disadvantages of the conventional pivotal support mechanisms.

### SUMMARY OF THE INVENTION

The primary objective of the present invention is to provide a pivotal support mechanism including a foldable and pivotal structure or configuration for suitably supporting the monitor or displayer or screen or mobile device at any suitable or selected position and for allowing the displayer or the monitor or the screen or the mobile device or the like to be easily and readily viewed or seen by the user.

In accordance with one aspect of the invention, there is provided a pivotal support mechanism comprising a supporting base, a pivotal arm device including a lever having a first end portion pivotally and frictionally attached to the supporting base for allowing the lever to be rotated and adjusted relative to the supporting base to a selected angular position, and a beam having a first end portion pivotally and frictionally attached to a second end portion of the lever for allowing the beam to be rotated and adjusted relative to the lever to a selected angular position, and the lever including an opening formed in the second end portion of the lever, and an electric facility pivotally and frictionally attached to a second end portion of the beam for allowing the electric facility to be rotated and adjusted relative to the beam to a selected angular position and arranged for allowing the electric facility or the mobile device or the like to be easily and readily viewed or seen by the user.

The supporting base includes a seat member disposed on the supporting base, and the first end portion of the lever is pivotally and frictionally attached to the seat member of the supporting base with a pivot shaft. The seat member is solidly and stably attached or mounted or secured to the supporting base with at least one fastener or the like.

The electric facility includes a seat element attached to the electric facility and pivotally and frictionally attached to the second end portion of the beam with a pivot spindle for allowing the electric facility to be rotated and adjusted relative to the beam. The seat element is attached to the electric facility with at least one fastener or the like.

The first end portion of the beam is pivotally and frictionally attached to the second end portion of the lever with a pivot axle for allowing the beam to be rotated and adjusted relative to the lever. The beam is engageable into the opening of the lever for allowing the length of the pivotal arm device to be suitably or selectively reduced or decreased.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a pivotal support mechanism in accordance with the present invention, for supporting various objects, such as mobile devices, tablets, screens, laptops, notebooks, etc.; and

FIGS. 2, 3, 4, 5 are other perspective views similar to FIG. 1, illustrating the operation of the pivotal support mechanism for supporting mobile devices.

### DETAILED DESCRIPTION OF THE PREFERRED EMBODIMENT

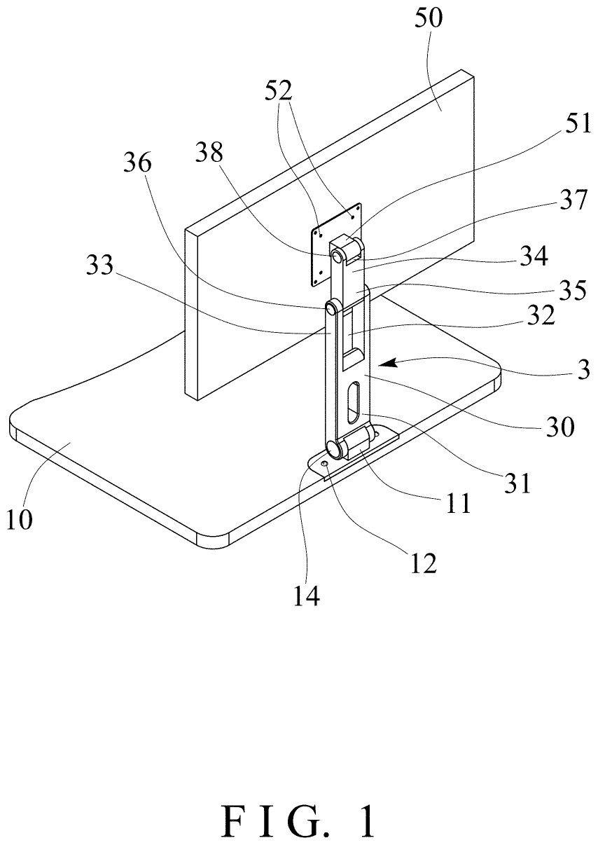

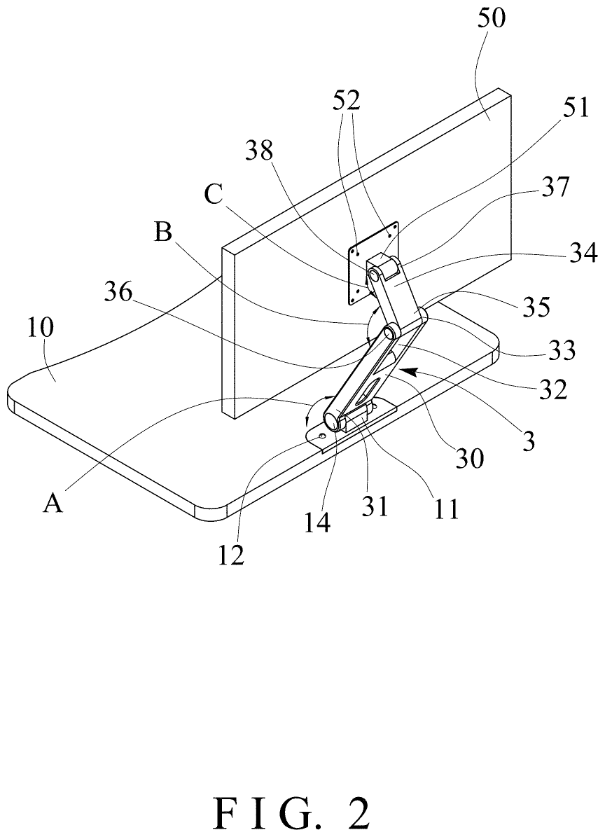

Referring to the drawings, and initially to FIGS. 1 and 2, a pivotal support mechanism or pivotal support mechanism in accordance with the present invention comprises a base plate or supporting base 10 for being supported on the ground or the other supporting surfaces (not illustrated), and a base or seat body or member 11 disposed or attached or mounted or secured onto the supporting base 10 with one or more screws or bolts or catches or latches or fasteners 12 or the like for attaching or mounting or securing or supporting a pivotal arm device 3 thereon, and/or for supporting an electric facility 50, such as a tablet, a computer, a notebook, a screen, a laptop, a mobile device 50 or the like on the supporting base 10 with the pivotal arm device 3.

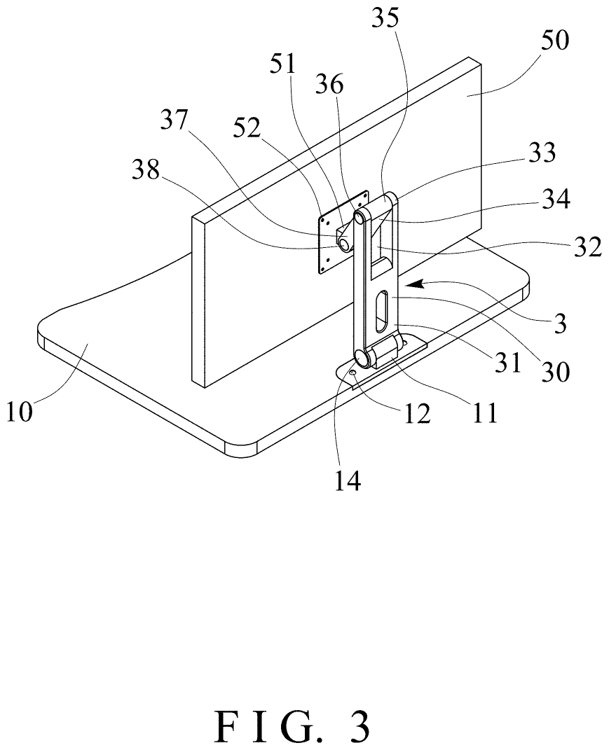

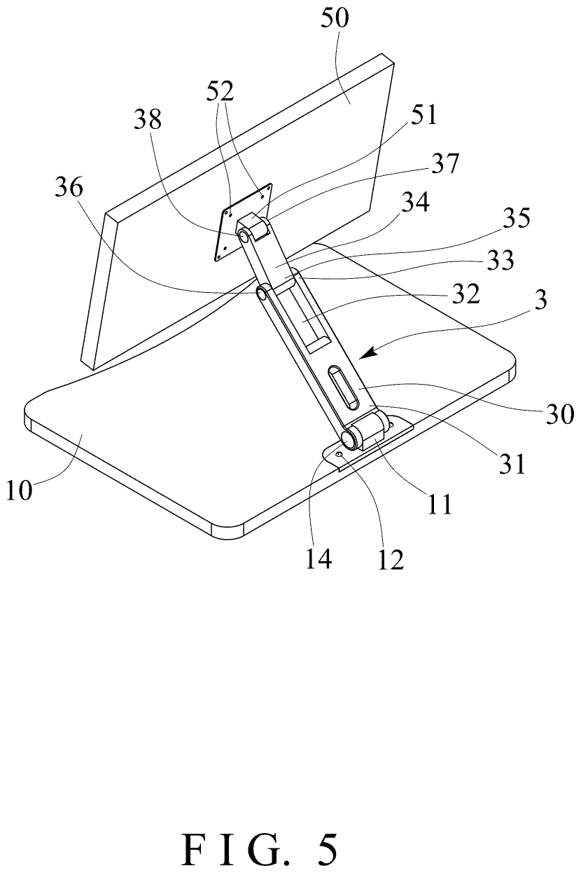

The pivotal arm device 3 includes an arm or lever 30 having one or lower or first end portion 31 pivotally or rotatably and frictionally attached or mounted or secured to the seat member 11 with a pivot spindle or shaft 14 and arranged for allowing the lever 30 to be pivoted or rotated or adjusted relative to the seat member 11 and the supporting base 10 (FIGS. 1-5) to any suitable or selected angular position or location or angle A (FIG. 2). The lever 30 includes a notch or opening 32 formed therein, such as formed in the other or upper or second end portion 33 thereof.

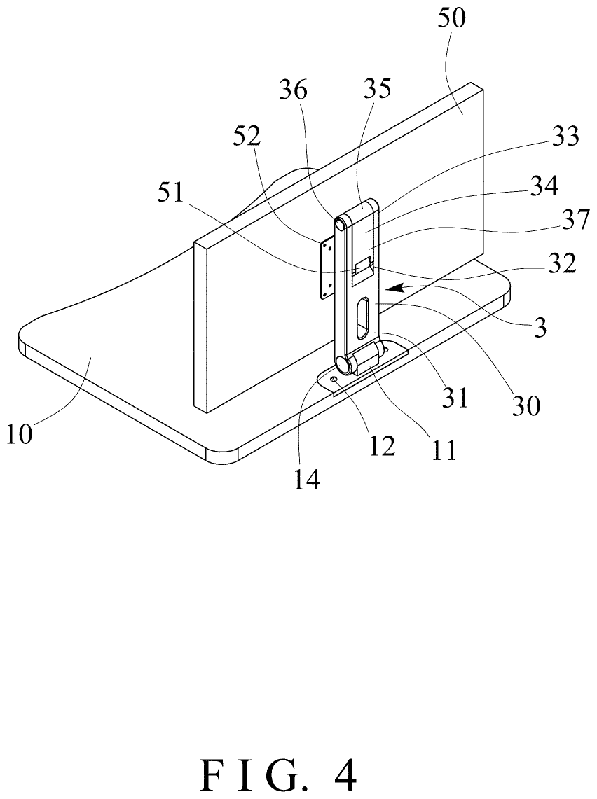

A stud or post or beam 34 includes one or first end portion 35 pivotally or rotatably and frictionally attached or mounted or secured to the other or upper or second end portion 33 of the lever 30 with a pivot spindle or axle 36 and arranged for allowing the beam 34 to be pivoted or rotated or adjusted relative to the lever 30 (FIGS. 1-5) to any suitable or selected angular position or location or angle B (FIG. 2), and arranged for allowing the beam 34 to be selectively engaged into the opening 32 of the lever 30 (FIG. 4), and thus for allowing the length of the pivotal arm device 3 to be suitably or selectively reduced or decreased.

Another base or seat body or element 51 is attached or mounted or secured to the electric facility 50 with one or more screws or bolts or catches or latches or fasteners 52 or the like. The beam 34 includes another or second end portion 37 pivotally or rotatably and frictionally attached or mounted or secured to the electric facility 50 and/or the seat element 51 with another pivot shaft or axle or spindle 38 and arranged for allowing the electric facility 50 to be pivoted or rotated or adjusted relative to the beam 34 (FIGS. 1-5) to any suitable or selected angular position or location or angle C (FIG. 2).

In operation, as shown in FIGS. 1-5, the electric facility 50 may be moved or pivoted or rotated or adjusted relative to the supporting base 10 with the pivotal arm device 3, and the lever 30 and the beam 34 of the pivotal arm device 3 may be moved or pivoted or rotated or adjusted relative to each other and/or relative to the supporting base 10 and the electric facility 50 to any suitable or selected angular position or location and thus for allowing the electric facility 50 to be easily and readily viewed or seen by the user.

Accordingly, the pivotal support mechanism in accordance with the present invention includes a foldable and pivotal structure or configuration for suitably supporting the monitor or displayer or screen or mobile device at any suitable or selected position and for allowing the displayer or the monitor or the screen or the mobile device or the like to be easily and readily viewed or seen by the user.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A pivotal support mechanism comprising:
a supporting base,
a pivotal arm device including a lever having a first end portion pivotally and frictionally attached to said supporting base for allowing said lever to be rotated and adjusted relative to said supporting base to a selected angular position, and a beam having a first end portion pivotally and frictionally attached to a second end portion of said lever for allowing said beam to be rotated and adjusted relative to said lever to a selected angular position, and said lever including an opening formed in said second end portion of said lever, and
an electric facility pivotally and frictionally attached to a second end portion of said beam for allowing said electric facility to be rotated and adjusted relative to said beam to a selected angular position.

2. The pivotal support mechanism as claimed in claim 1, wherein said supporting base includes a seat member disposed on said supporting base, and said first end portion of said lever is pivotally and frictionally attached to said seat member of said supporting base with a pivot shaft.

3. The pivotal support mechanism as claimed in claim 2, wherein said seat member is attached to said supporting base with at least one fastener.

4. The pivotal support mechanism as claimed in claim 1, wherein said first end portion of said beam is pivotally and frictionally attached to said second end portion of said lever with a pivot axle.

5. The pivotal support mechanism as claimed in claim 1, wherein said electric facility includes a seat element attached to said electric facility and pivotally and frictionally attached to said second end portion of said beam with a pivot spindle.

6. The pivotal support mechanism as claimed in claim 5, wherein said seat element is attached to said electric facility with at least one fastener.

7. The pivotal support mechanism as claimed in claim 1, wherein said beam is engageable into said opening of said lever.
